(19) United States
(12) Patent Application Publication
(10) Pub. No.: US 2026/0243561 A1
(43) Pub. Date: Aug. 20, 2026

(54) Measurement System for a Model

(71) Applicant: Bayerische Motoren Werke Aktiengesellschaft, Muenchen (DE)

(72) Inventors: Andreas WELTMAIER, Erding (DE); Helmut ZENS, Wielenbach (DE)

(21) Appl. No.: 19/144,987

(22) PCT Filed: Jan. 26, 2024
(86) PCT No.: PCT/EP2024/051931

§ 371 Date: Jul. 1, 2025

(30) Foreign Application Priority Data
Feb. 1, 2023 (DE) 10 2023 102 391.8

(51) Int. Cl. G01B 11/27

(52) U.S. Cl. CPC G01B 11/27

(57) ABSTRACT

A measurement system comprises a frame to which a plurality of reference bodies are attached; an optical detection system for scanning the reference bodies; and a processing device. The processing device is configured to determine an orientation of the frame with respect to the detection system based on a scanning of the reference bodies. The reference bodies can be removed from the frame and attached to the frame with repeat accuracy.

### BACKGROUND AND SUMMARY

The invention relates to a measurement system for scanning a model. In particular, the invention relates to a measurement system for a model that represents part of a motor vehicle.

In the development of a motor vehicle, a model will be produced for a part, assembly or section of the vehicle in order to test its functional or aesthetic effect. The model may consist of a flexible material such as clay, which can be molded into a shape that replicates the surface of the motor vehicle. If a suitable shape is found, the model is scanned in order to be able to archive or further process its shape using computer-aided methods.

The scanning can be carried out by means of an optical measurement device or measurement system that detects a large number of points on the surface of the model. However, a shape that is found in this way does not have a defined orientation in space. For example, in order to be able to compare surfaces of the model in two different revisions, it is necessary for the scans to be referenced to the same coordinate system.

It is standard practice to mount the model on a scanning plate in a defined manner for a scanning operation. The scans performed by means of the measurement system can then be referenced to a coordinate system that is defined with respect to the scanning plate. The fixed reference of a coordinate system of the model with respect to the measurement plate also allows the scans to be related to a coordinate system of the model.

However, this procedure requires the model to be mounted on the measurement plate with repeatable accuracy for each individual scanning operation. To do this, the model must be moved to the scanning plate and aligned exactly with it. Transporting and adjusting the model in relation to the measurement plate can be complex and time-consuming. This can delay a design process for the model, which can result in increased development costs.

An object of the present invention is to provide an improved technique for providing a scan of a model. The invention addresses this object by means of the subject matter of the independent claims. Dependent claims reproduce further embodiments and implementations.

A proposed measurement system comprises a frame to which a plurality of reference bodies are attached; an optical acquisition system for scanning the reference bodies; and a processing device. The processing device is configured to determine an orientation of the frame with respect to the acquisition system on the basis of a scan of the reference bodies. The reference bodies can be removed from the frame and attached to the frame with repeatable accuracy.

The measurement system can be used to easily define a coordinate system that is related to the frame. Subsequent scans of the frame or an associated model can be related to the defined coordinate system without requiring that the frame be oriented in a predetermined manner. The use of a measurement plate may be necessary only once in order to define the frame-fixed coordinate system.

Sufficient repeatability is generally obtained if scans by the acquisition system before and after the removal and reattachment of the reference bodies are comparable to each other within a predetermined measurement accuracy. In other words, after removal from the frame, the reference bodies should be able to be reattached to the frame in the same exact positions so that any deviation from defined positions of a point related to the frame before and after temporary removal is less than a predetermined amount. This amount may correspond to the measurement accuracy.

The removable reference bodies do not interfere with a model design process on the frame. The reference bodies may be attached to the frame only when a scan is to be carried out. A model can be scanned more quickly overall and with fewer technical resources.

The frame is preferably configured to support a model. In this case, the acquisition system is configured to scan the model and the processing device is configured to align a scan of the model on the basis of the defined orientation of the frame.

In other words, the processing device can relate a point on the surface of the model, scanned by means of the acquisition system, to a coordinate system which has been defined relative to the frame only once. The model can have a variable shape. The material of the model can be chosen arbitrarily and a shape of the model can be arbitrarily complex, provided the shape can be scanned by means of the acquisition system. A size of the model can be determined substantially only by the handling capability of the frame. A positionally fixed acquisition system may present a further restriction. Alternatively, a mobile or hand-held acquisition system can be used.

It is preferred that a number of optical markers are attached to the model, wherein the processing device is configured to align two overlapping scans of the model with respect to the position of markers detected in both scans relative to each other. A marker can also be referred to as a reference point.

Markers can be attached to the model before scanning and then removed. It may be sufficient if the markers are distributed pseudo-randomly over a surface of the model. The distribution of the reference points on the model may depend on the measurement volume used and/or the scanning system used. Information provided by a scanning system manufacturer can be used to distribute and attach reference points. A series of scans can be created using the acquisition system, wherein two adjacent scans should partially overlap each other in order to create a common context of the scans. This allows a chain or series of scans to be created, the detected reference points of which are all in the same coordinate system. The entire series can be related to the coordinate system of the frame if a sufficient number of reference bodies can be detected in the scans when taken together. It is preferred that a plurality of reference bodies are detected in only one scan.

In one embodiment, a reference body carries an individual optical marker, which can be detected by means of the acquisition system.

Thus, any confusion of reference bodies during evaluation by the processing device can be ruled out. Any ambiguities in the relation of a scan to the frame-fixed coordinate system can be resolved. It is also preferred that the reference bodies are assigned to predetermined positions on the frame. Thus, a position of scanned points on the surface of the model can be related more accurately and uniquely to the frame-fixed coordinate system.

In some implementations, the positions are selected such that a constellation of reference bodies on the frame results in an advantageous geometric form. For example, a surface spanned by the reference bodies or a volume spanned by the reference bodies can be maximized as much as possible. In order to align the frame correctly in space, three rotational degrees of freedom and three translational degrees of freedom should normally be specified. It may be sufficient to use at least three reference bodies. However, in some implementations, at least six reference bodies are used to provide a sufficient number of reference points for the referencing of the frame-fixed coordinate system.

In some implementations, predetermined mechanical interfaces for tool-free separation and connection are provided between the reference bodies and the frame.

Fitting the frame with the reference bodies can be completed by one person within a short time. The interface is configured to hold the reference body on the frame with sufficiently repeatable accuracy.

In some implementations, the reference bodies are attached to the frame only for the purpose and for the duration of a scan. Therefore, the interfaces do not need to be so robust that they can withstand unintentional contact during the processing of the model. Due to the tool-free connection and separation of the reference body from the frame, the tooling effort before or after the scanning can be reduced.

If a reference body is individually assigned to a position on the frame, the interface may comprise a mechanical coding that prevents another reference body from being attached to that position. However, interfaces of multiple reference bodies can also be interchangeable.

In some implementations, a frame-fixed section of the interface is attached in such a way that the reference body can be connected to it without touching the model. For example, the frame may be configured such that the model is placed on the top of the frame and an interface is located on the underside. In another embodiment, the interface may be located in a region in which the model has a recess or a cavity.

In some implemenations, an interface comprises two surfaces for mutual contact, wherein sections corresponding to each other are formed on the surfaces to allow mutual positive-locking engagement. The surfaces are assigned to different sections of the interface and can be separated from each other when the interface is opened. The surfaces allow a reference body to be placed reproducibly and accurately in a predetermined position relative to the frame. The positive-locking sections can prevent the surfaces from moving relative to each other. The surfaces can include planes or curved surfaces. Concave or convex sections that correspond to each other may include, for example, a hemisphere, a prism, a cylinder, a slot or a cone. A plurality of sections for positive-locking engagement may be distributed over the surfaces in a predetermined manner. The position of the reference body relative to the frame may be determined or overdetermined.

In some implementations, the interface comprises a magnetic fixing between the reference body and the frame. The fixing is preferably configured to approximate the reference body to the frame. This allows a positive-locking fit to be established or maintained by mutually corresponding sections. The magnetic fixing can be created or disconnected quickly. Under excess loading the fixing can open so that the reference body is separated from the frame.

In some implementations, a side arm is provided between the reference body and the frame. Thus, the reference body can protrude beyond an outline of the model without a frame-fixed part of the interface preventing the inward pressure or the ability to work on the model when the reference body is removed.

In a development, a subframe is movably mounted on the frame. At least one additional reference body may be attached to the subframe. Depending on the number of degrees of freedom of the subframe relative to the frame, multiple reference bodies may also be provided. To provide a complete definition of an orientation of the subframe with respect to the frame-fixed coordinate system, at least three reference bodies are preferably used.

The movable subframe can support a function of the model. For example, the subframe may represent a door of a vehicle, the door being movable relative to the vehicle in the same way as the subframe relative to the frame. For example, it can thus be tested whether independently defined shapes of the vehicle and the door are compatible with each other with respect to a predetermined mobility. A subframe can be designed to be separable from the frame. An interface between the frame and the subframe can then ensure a repeatably accurate re-attachment after separation. In an extension of the idea, a plurality of subframes can also be movably attached to the frame. The concept can also be cascaded by movably attaching another subframe to the subframe.

A method for scanning a model supported by a frame comprises steps of: attaching a plurality of reference bodies to the frame; optically scanning the reference bodies; defining a frame-fixed coordinate system based on a scan of a predetermined number of reference bodies; temporarily removing the reference bodies; and repeating the scan.

The method can be carried out in particular by means of a measurement system described herein. The temporary removal of the reference bodies can allow the model to be processed to an arbitrary extent. Compared to a conventional method, an external device for defining the coordinate system may only be required once. Any number of subsequent scans can then be aligned with respect to the already defined coordinate system.

The method allows scans of different revisions of the same model to be performed on a frame with less effort. This enables easier referencing between different scans of the model. In an extension of the method, different scans of the model can therefore be compared with one another. Differences between two revisions or versions of the model can thus be better identified and quantified. Unchanged parts of the model can be identified.

The invention is now described in more detail with reference to the accompanying drawings, in which:

### BRIEF DESCRIPTION OF THE DRAWINGS

FIG. 1 shows a measurement system;

FIG. 2 shows a flow chart of a method;

FIG. 3 shows a frame with a model for an interior;

FIG. 4 shows a reference body on a frame;

FIG. 5 shows an exemplary reference body with a mechanical interface;

FIG. 6 shows a reference body in a further embodiment.

### DETAILED DESCRIPTION OF THE DRAWINGS

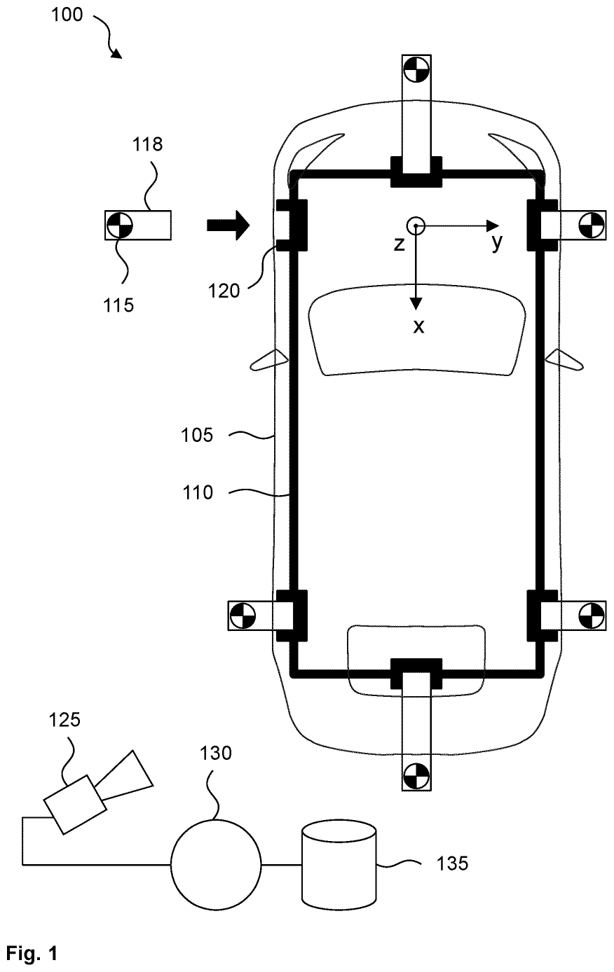

FIG. 1 shows a measurement system 100. The measurement system 100 is designed to provide scans of a model 105, which is preferably used in the development process of a motor vehicle. Although smaller elements can also be processed with the measurement system 100, the model 105 is illustrated using the example of a complete motor vehicle.

The measurement system 100 comprises a frame 110 which is designed to support the model 105, and to which a plurality of reference bodies 115 can be attached. The reference body can be set apart from the frame 110 via a side arm 118. Between the frame 110 and the reference body 115, a mechanical interface 120 is preferably provided. Furthermore, the measurement system 100 comprises an optical acquisition system 125 and a processing device 130. A data storage device 135 is optionally provided.

The frame 110 is dimensioned such that it can support the model 105 without being excessively deformed with regard to its influence on a measurement result. For larger models 105, the frame 110 is usually a tubular steel construction. The model 105 can be made of a flexible or curable material such as clay or plastic. For weight reasons, the space between the model 105 and the frame 110 can be occupied by a filler, which may comprise, for example, a fully cured plastic foam.

Frame-side interfaces 120 are preferably mounted on the frame 110 in such a way that they are outside a region in which the model 105 is located. In addition, the interfaces 120 are further preferably designed such that they cannot, or not unintentionally, be repositioned on the frame 110. A non-repositionable interface 120 can, for example, be fastened to the frame 110 in a materially-bonded manner. A repositionable interface 120 may require the use of a key, a predetermined tool or the breaking of a seal in order for its position to be changed relative to the frame 110.

The frame 110 can be configured to be mechanically aligned with respect to a base plate, not shown. For this purpose, an adapter can be used on the base plate, which can engage in a positive-locking manner in a corresponding structure on the frame 110. Such an adapter can also be called a quill.

The acquisition system 125 is designed to determine the position of at least one point on a surface of an object in a contactless manner and in particular by optical means. Typically, a plurality of several 100 or several 1000 points of a surface can be detected by means of the acquisition system 125 with only a single recording or measurement run. A position of the acquisition system 125 relative to the frame 110 can be determined at least initially, if both the frame 110 and the acquisition system 125 are positioned opposite the measurement plate. For this purpose, a frame-fixed coordinate system, i.e. one that is related to the frame 110, can be defined.

As an example, FIG. 1 shows a Cartesian coordinate system which is defined relative to the frame 110. An x-axis extends horizontally to the rear, opposite to a normal direction of travel of the vehicle. A y-axis runs horizontally from left to right. A z-axis extends vertically upwards. The origin of the coordinate system lies on an axis around which both front wheels of the vehicle can rotate, halfway between the left and right wheels. A different definition can also be made. Optionally, a system other than an orthogonal system or other than a Cartesian system can also be used.

Before the start of a scanning process, the processing unit 130 can generate a coordinate system in the detection range of the acquisition system 125, which is also referred to as the sensor coordinate system. Once the acquisition is complete, this coordinate system can be transformed into a different one. In the illustration of FIG. 1, no sensor coordinate system is indicated and it is assumed, without restriction of generality, that all measurements are transformed into the x/y/z coordinate system shown before further processing.

Certain points can be stored in the data storage device 135. Optionally, the points can also undergo processing by the processing device 130, for example, smoothing, a transformation into a different data format or the creation of a model on the basis of different geometric constructs, for example NURBs (Non-Uniform Rational B-Spline). The points or a processing result can be made available externally.

In different embodiments, the acquisition system 125 can be room-fixed, mobile or hand-held. In a room-fixed acquisition system 125, a device is provided which can mechanically control or limit a position of the acquisition system 125. An orientation of the acquisition system 125 with respect to an environment, and in particular a measurement plate, can thus always be known. A mobile acquisition system 125 can be mounted on an autonomous platform that can, for example, travel around the model 105.

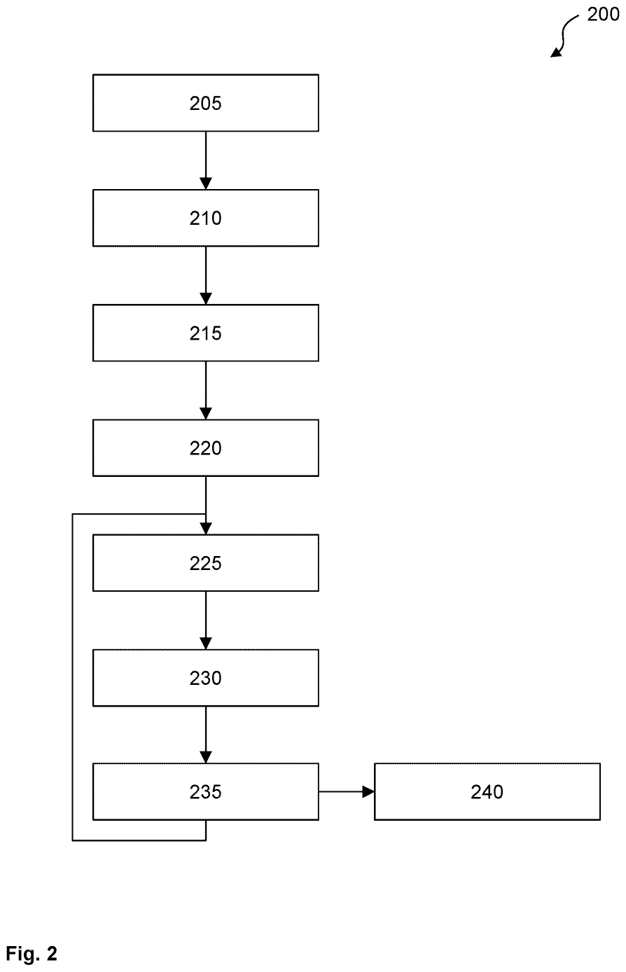

FIG. 2 shows a flow diagram of a method 200 for scanning a model 105. The method 200 can be executed in particular by a measurement system 100.

In a step 205, the frame 110 for the model 105 can be provided. The model 105 is preferably not yet attached to the frame 110 at this point in time.

In a step 210, reference bodies 115 can be attached to the frame 110. Positions for the reference bodies 115 on the frame 110 can be specified at this time. It is preferred that at least six reference bodies 115 are used. The reference bodies 115 can be located relative to each other in a plane or in any other geometric structure. More preferably, the reference bodies 115 are positioned on the frame 110 such that they can be seen from the largest possible angular range. The angular range can be defined horizontally and/or vertically.

In a step 215, the frame 110 can be calibrated. A frame-fixed coordinate system can be defined in the process. A position on the surface of the model 105 determined later can be related to the frame-fixed coordinate system. The frame-fixed coordinate system is a prerequisite for the comparability of different scans of the model 105 in possibly different states or shapes.

Relative positions of the reference bodies 115 to each other can be determined for calibration. For example, the coordinate system can be defined manually. It is preferred that a Cartesian orthogonal system be used. In the embodiment shown in FIG. 1, the coordinate system may be defined in such a way that a first axis corresponds to a longitudinal axis, a second axis to a transverse axis and a third axis to a vertical axis of a motor vehicle represented by the model 105. Directions and origins of the axes can be defined freely or according to an existing convention. In some implementations, a 3-2-1 alignment is carried out via geometry elements of the measurement plate. An origin of the coordinate system can then be moved to a predetermined position, for example, in the center of the front axle as shown.

In some implementations, the coordinate system is defined automatically by exploiting a predetermined geometric relationship between reference bodies 115. For example, any two reference bodies can define an axis. The axes can intersect at a point that can be defined as the origin of the coordinate system.

In other implementations, the coordinate values of the reference bodies are acquired and, after an optional corrective alignment, entered as TARGET coordinate values into a software application running on the processing device 130. Subsequently, the data scanned by means of the acquisition system 135 can be stored in the form of coordinate values of the pattern of detected reference points, as well as a position of an origin and an orientation of the coordinate system.

The reference bodies 115 can be removed from the frame 110 in a step 220. The reference bodies 115 can be stored in a safe place so that they are available at a later date for the present frame 110 or the model 105 that it supports.

In a step 225, the model 105 can be attached to the frame 110 or processed. The processing can include modifying the surface of the model 105. There is no limit in principle to the extent or scope of a modification.

In a step 230, the reference bodies 115 can be attached to the frame 110 again. The reference bodies 115 can be individually marked. A first marker can be legible by a person, a second marker can be scanned by the acquisition system 125 and detected by means of the processing device 130. When attaching, care is preferably taken to ensure that the reference bodies 115 each occupy the same positions on the frame 110 that they had in step 215.

In a step 235, the model 105 can be measured. For this purpose, the surface of the model 105 can be scanned by means of the acquisition system 125. At the same time, one or more reference bodies 115 can be scanned. Typically, a scan comprises a plurality of points that lie within a predetermined measurement range. Multiple scans that partially overlap each other can be merged into an enlarged scan.

Each point of the scan can be related to the frame-fixed coordinate system by determining its position relative to a reference body 115 recognizable on the scan, and taking into account its position relative to the frame-fixed coordinate system. The referencing of a scan to the frame-fixed coordinate system can be carried out in a known manner by transposition using appropriate matrices.

If the scanned pattern of reference points comprises three or more reference bodies, a transformation of all ACTUAL data to the previously stored TARGET data can be determined. All data in the project can be transformed. Then the scan data, i.e. the acquired positions of the reference points, can be available in the coordinate system of the vehicle without the physical model 105 having to be set up again on quills on the base plate.

After the measurement of the model 105, the method 200 can be continued in step 225 in order to perform a new modification to the model 105 and to determine its result. In a step 240, the model 105 can be evaluated on the basis of its scan. The evaluation can be carried out in any desired way. For example, the scan can be used as a basis of a simulation of the model 105 in a wind tunnel. In another embodiment, a computer graphic can be created on the basis of the scan, which can be colored, animated or otherwise developed in further processing steps. In step 240, different revisions of the model 105 can also be compared with each other. For this purpose, parts of the model 105 that have changed between two predetermined revisions can be identified.

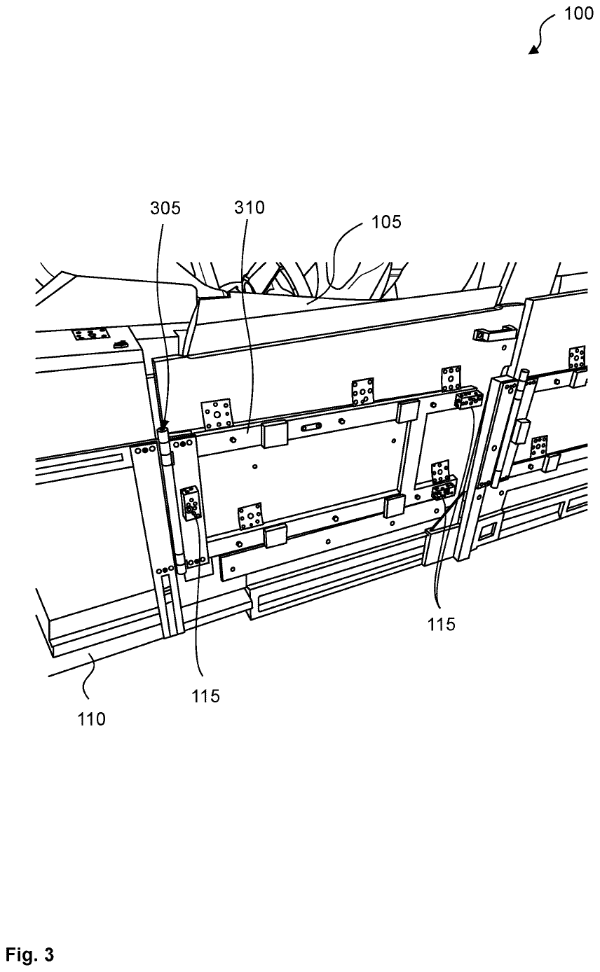

FIG. 3 shows a frame 110 with a model 105 for an interior of a motor vehicle. The frame 110 is shown from an outer side, and the model 105 is located on a side of the frame 110 facing away from the viewer. A subframe 310 is mounted on the frame 110 so as to be movable relative to the frame 110 in a predetermined manner. In the embodiment shown, the subframe 310 is mounted so as to be pivotable relative to the frame 110 about a predetermined axis 305. As an option, the subframe 310 can also be removed from the frame 110. The mobility of the subframe 310 relative to the frame 110 in the illustrated embodiment represents the mobility of a door of a motor vehicle simulated by the model 105.

A plurality of reference bodies 115 are preferably mounted on the subframe 310. The reference bodies 115 can be detected from the outer side of the body not relevant to the model 105. Thus, a position of the modeled door relative to the rest of the motor vehicle can be determined.

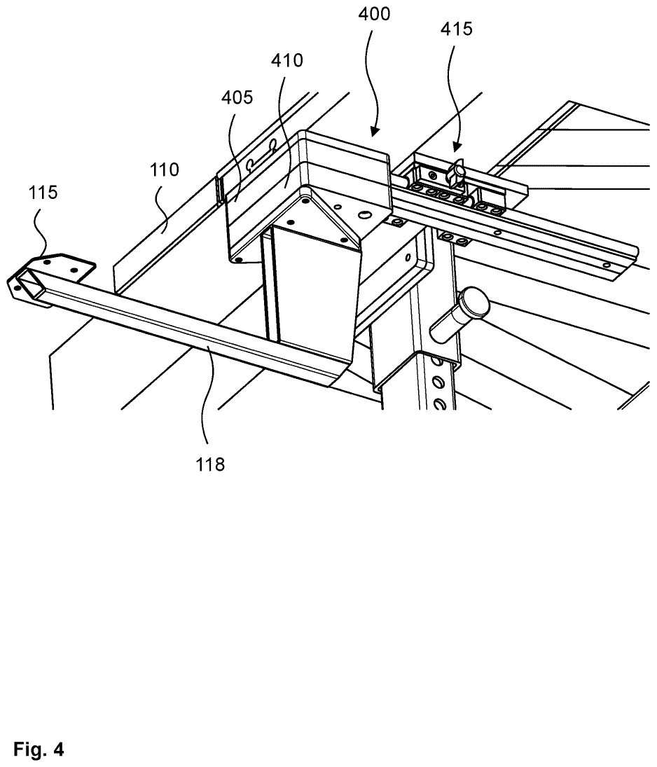

FIG. 4 shows an example of a reference body 115 on a frame 110. A model 105 can be located on the top of the frame 110 facing away from the viewer. A mechanical interface 400 is provided between the reference body 115 and the frame 110, comprising a frame-fixed section 405 and a section 410 that is fixed relative to the reference body 115. The side arm 118 is located between the reference body 115 and the second section 410 and is shaped in such a way that it does not extend into the region of the model 105 and can be well captured by the acquisition system 125 on the model 105.

In the embodiment shown, an adjustment mechanism 415 is provided with which a position of the first section 405 of the mechanical interface 400 can be adjusted. The mechanism 415 is preferably only used once to initially define a position of the reference body 115. For subsequent measurement or processing operations on the model 105, the mechanism 415 can be removed or locked. Optionally, the height of the reference body 115 on the frame 110 can be adjusted by attaching a spacer plate. Again, no change in the relative position is provided after the initial definition.

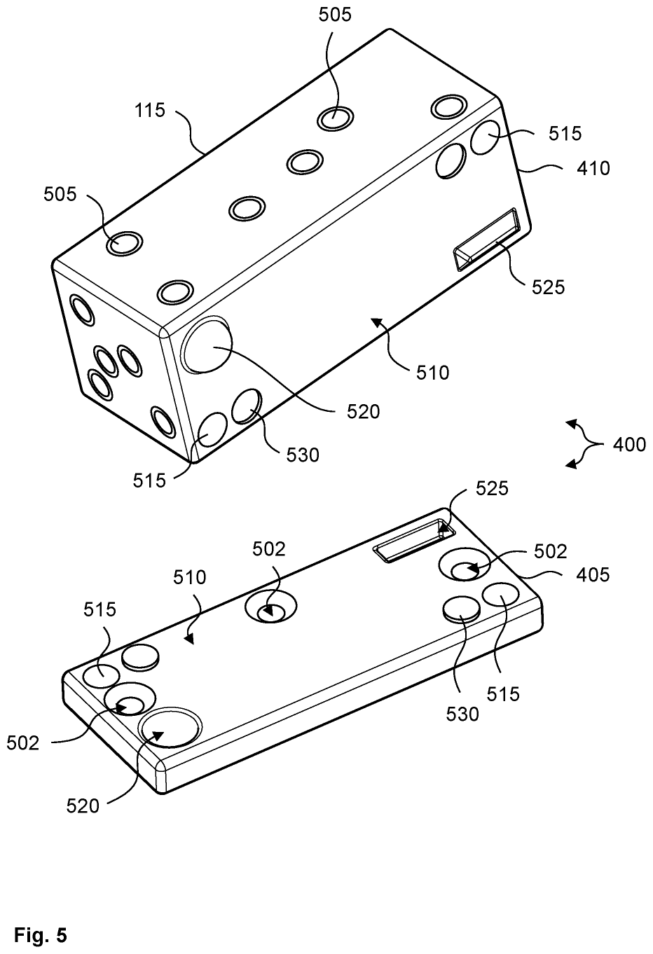

FIG. 5 shows an exemplary reference body 115 with a mechanical interface 400 for fastening to a frame 110. The first section 405 is realized by a plate that can be attached to the frame 110. A mounting hole 502 or another structure may be provided for the attachment. The second section 410 is formed directly on the reference body 115, which has, for example, the shape of a cuboid.

On the surface of the reference body 115, exemplary optical markers 505 are shown. The markers 505 may be attached to the five surfaces of the cuboidal reference body 115 which are not covered by the second section 410 of the mechanical interface 400.

Sections 405 and 410 may each have a surface 510 which are designed for mutual contact with each other. For fixing the sections 405, 410 to each other, a magnetic fixing 515 may be provided, which can comprise a combination of two permanent magnets or one permanent magnet and a matching piece of metal. The fixing 515 is preferably designed to press the surfaces 510 against each other.

For the unique positioning of the second section 410 on the first section 405. structures may be formed on both sides, which are designed to engage with each other in a positive-locking manner.

A first example structure 520 comprises a ball section and a ball socket. In the present case, the ball socket 520 is formed on the first section 405 and the ball section 520 is formed on the second section 410. If the ball section engages in the ball socket, this will prevent lateral displacement of the sections 405, 410 along the surfaces 510.

A second exemplary structure 525 comprises a prism and a slot. In this case, by way of example, the slot is shown on the first section 405 and the prism on the second section 410. The second structure 525 also defines a rotational position of sections 405, 410 about a rotational axis that runs perpendicular to the surfaces 510.

A third exemplary structure 530 comprises a cylinder and a corresponding hollow cylinder. The cylinder in the illustrated embodiment is formed on the first section 405 and the hollow cylinder on the second section 410.

It is preferred that the mechanical interface 400 comprise a plurality of structures 520 to 530 in order to adjust an orientation of the reference body 115 relative to the first section 405 or the frame 110 in a reproducible and unique manner with respect to the available degrees of freedom.

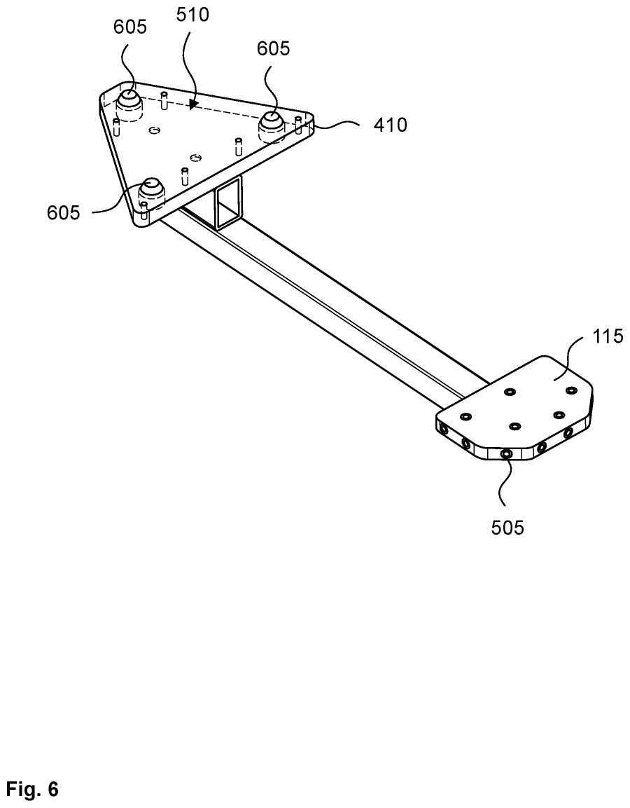

FIG. 6 shows a reference body 115 in a further embodiment. The reference body 115 shown is substantially plate-shaped with an exemplary pentagonal footprint. The second section 410 is connected to the reference body 115 via a side arm 118. The second section 410 is also embodied in the shape of a plate and, in the embodiment shown, comprises a surface 510 for contacting a corresponding first section 405, and three structures 605 which are formed in the surface 510 of the second section 410.

The structures 605 are designed as three spaced-apart frustums extending upwards from the surface 510. In the corresponding first section 405 of the mechanical interface 400, concave receptacles matching these can be formed. The frustums 605 are spaced apart from each other substantially in the manner of an equilateral triangle. Optionally, a magnetic fixing 515 may be formed between a frustum and a receptacle. In another embodiment, a fixing 515 may also be formed between the structures 605.

### REFERENCE SIGNS

100 Measurement system
105 Model
110 Frame
115 Reference body
118 Side arm
120 Interface
125 Acquisition system
130 Processing device
135 Data storage device
200 Method
205 Provide frame
210 Attach reference body
215 Calibrate the frame, define frame-fixed coordinate system
220 Remove reference body
225 Create/process model
230 Attach reference body
235 Measure model
240 Evaluate model
305 Axle
310 Subframe
400 Mechanical interface
405 First section, frame-fixed
410 Second section, frame-fixed
415 Adjustment mechanism
502 Mounting hole
505 Optical marker
510 Surface
515 Magnetic fixing
520 First structure, ball section and ball socket
525 Second structure, prism and slot
530 Third structure, cylinder and hollow cylinder
605 Fourth structure, frustum and receptacle

1-12. (canceled)

13. A measurement system, comprising:
a frame configured to attached to a plurality of reference bodies;
an optical acquisition system configured to scan the plurality of reference bodies; and
a processor configured to determine an orientation of the frame with respect to the optical acquisition system on a basis of a scan of the plurality of reference bodies;
wherein the reference bodies are configured to be removed from the frame and attached to the frame with repeatable accuracy.

14. The measurement system of claim 13, wherein:
the frame is configured to support a model;
the optical acquisition system is configured to scan the model; and
the processor is further configured to align a scan of the model on a basis of the determined orientation of the frame.

15. The measurement system according to claim 14, wherein:
a number of optical markers is attached to the model; and
the processor is further configured to align two overlapping scans of the model with respect to a position of markers detected in both scans relative to each other.

16. The measurement system according to claims 13, wherein a reference body carries an individual optical marker, which can be detected by means of the acquisition system.

17. The measurement system according to claim 13, wherein the reference bodies of the plurality of reference bodies are assigned to predetermined positions on the frame.

18. The measurement system according to claim 13, wherein predetermined mechanical interfaces for tool-free separation and connection are provided between the reference bodies and the frame.

19. The measurement system according to claim 18, wherein:
one interface comprises two surfaces for mutual contact; and
sections corresponding to each other are formed on the surfaces to allow mutual positive-locking engagement.

20. The measurement system according to claim 18, wherein one interface comprises a magnetic fixing between the reference body and the frame.

21. The measurement system according to claim 13, wherein a side arm is provided between the reference body and the frame.

22. The measurement system according to claim 13, wherein:
a subframe is movably mounted on the frame; and
at least one further reference body is attached to the subframe.

23. A method for scanning a model which is supported by a frame, the method comprising:
attaching a plurality of reference bodies to the frame;
optically scanning the reference bodies;
defining a frame-fixed coordinate system based on a scan of a predetermined number of reference bodies;
temporarily removing the reference bodies; and
repeating the scan.

24. The method according to claim 23, further comprising comparing the scans.
